(19) United States
(12) Patent Application Publication
(10) Pub. No.: US 2017/0053276 A1
(43) Pub. Date: Feb. 23, 2017

(54) Systems and Methods for Transaction Routing

(71) Applicant: Green Dot Corporation, Pasadena, CA (US)

(72) Inventors: David Gullett, Moorpark, CA (US); Anthony Peculic, Pasadena, CA (US)

(73) Assignee: Green Dot Corporation

(21) Appl. No.: 14/832,678

(22) Filed: Aug. 21, 2015

(51) Int. Cl. G06Q 20/40; G06Q 20/02

(52) U.S. Cl. CPC G06Q 20/405; G06Q 20/023

(57) ABSTRACT

Systems and methods for transaction routing in accordance with embodiments of the invention are disclosed. In one embodiment, a method for routing transactions includes obtaining transaction data using an account servicing server system, where the transaction data includes metadata identifying a consumer account and the account servicing server system includes a processor and a memory connected to the processor, identifying routing rule data based on the transaction data using the account servicing server system, generating transaction request data based on the routing rule data and the transaction data using the account servicing server system, where the transaction request data includes at least one routing number and one account number identifying a financial account, and providing the transaction request data to at least one financial institution system using the account servicing server system, where the at least one financial institution system services the identified financial account.

### FIELD OF THE INVENTION

The present disclosure relates generally to financial services systems, and relates, more particularly, to processing financial transactions.

### BACKGROUND

The financial services industry provides a plethora of financial services to consumers for managing their finances and engaging in financial transactions with retailers and service providers. Consumers may hold funds within many different types of accounts at many different types of financial institutions. Consumers may access the funds held in the accounts using many different types of cards, including credit cards, debit cards, gift cards, and other types of cards based on the particular type of account associated with the card. The cards may be issued from financial institutions, such as banks, credit unions, savings & loans, and brokerage institutions.

A payment processor is a company that handles transactions for one or more financial institutions. Many payment processors have connections to various card associations and supply authorization and settlement services to the financial institutions. Several payment processors facilitate the movement of funds between payment processors and financial institutions. Payment processors can verify aspects of proposed transactions. Once the payment processor has received confirmation or denial of the verification, the information can be relayed to the financial institution that can then complete or invalidate the payment transaction accordingly.

### SUMMARY OF THE INVENTION

Systems and methods for transaction routing in accordance with embodiments of the invention are disclosed. In one embodiment, a method for routing transactions includes obtaining transaction data using an account servicing server system, where the transaction data includes metadata identifying a consumer account and the account servicing server system includes a processor and a memory connected to the processor, identifying routing rule data based on the transaction data using the account servicing server system, generating transaction request data based on the routing rule data and the transaction data using the account servicing server system, where the transaction request data includes at least one routing number and one account number identifying a financial account, and providing the transaction request data to at least one financial institution system using the account servicing server system, where the at least one financial institution system services the identified financial account.

In an additional embodiment of the invention, the account servicing server system further includes a network device connected to the processor and communicating via an Automated Clearing House (ACH) network and the transaction data is obtained via the ACH network.

In an additional embodiment of the invention, the method further includes obtaining confirmation data using the using the account servicing server system, where the confirmation data is provided by the at least one financial institution system.

In yet another additional embodiment of the invention, the method further includes authenticating the transaction data using the account servicing server system.

In still another additional embodiment of the invention, the transaction data is authenticated by determining the source system providing the transaction data using the account servicing server system and verifying that the source system is authorized to conduct transactions with the consumer account using the account servicing server system.

In yet still another additional embodiment of the invention, the transaction data further includes location data identifying the location that the transaction originated from and the routing rule data is identified based on the location data.

In yet another embodiment of the invention, the transaction data further includes metadata identifying the source system providing the transaction data and the routing rule data is identified based on the source system.

In still another embodiment of the invention, the transaction data further includes a timestamp identifying when the transaction was requested and the routing rule data is identified based on the timestamp.

In yet still another embodiment of the invention, the consumer account includes a routing number and an account number and the metadata identifying the consumer account includes the routing number and the account number.

In yet another additional embodiment of the invention, the transaction data is provided by a source system and the routing number and the account number identifying the consumer account are unique to the source system.

Still another embodiment of the invention includes an account servicing server system including a processor and a memory connected to the processor and storing an account servicing application, wherein the account servicing application directs the processor to obtain transaction data, where the transaction data includes metadata identifying a consumer account and identify routing rule data based on the transaction data, generate transaction request data based on the routing rule data and the transaction data, where the transaction request data includes at least one routing number and one account number identifying a financial account, provide the transaction request data to at least one financial institution system, where the at least one financial institution system services the identified financial account.

In yet another additional embodiment of the invention, the account servicing server system further includes a network device connected to the processor and communicating via an Automated Clearing House (ACH) network and the transaction data is obtained via the ACH network.

In still another additional embodiment of the invention, the account servicing server application further directs the processor to obtain confirmation data provided by the at least one financial institution system.

In yet still another additional embodiment of the invention, the account servicing server application further directs the processor to authenticate the transaction data.

In yet another embodiment of the invention, the transaction data is authenticated by determining the source system providing the transaction data and verifying that the source system is authorized to conduct transactions with the consumer account.

In still another embodiment of the invention, the transaction data further includes location data identifying the location that the transaction originated from and the routing rule data is identified based on the location data.

In yet still another embodiment of the invention, the transaction data further includes metadata identifying the source system providing the transaction data and the routing rule data is identified based on the source system.

In yet another additional embodiment of the invention, the transaction data further includes a timestamp identifying when the transaction was requested and the routing rule data is identified based on the timestamp.

In still another additional embodiment of the invention, the consumer account includes a routing number and an account number and the metadata identifying the consumer account includes the routing number and the account number.

In yet still another additional embodiment of the invention, the transaction data is provided by a source system; and the routing number and the account number identifying the consumer account are unique to the source system.

### BRIEF DESCRIPTION OF THE DRAWINGS

FIG. 1 is a conceptual illustration of an account servicing system in accordance with an embodiment of the invention.

FIG. 2 is a conceptual illustration of an account servicing server system in accordance with an embodiment of the invention.

FIG. 3 is a flow chart illustrating a process for creating a consumer account in accordance with an embodiment of the invention.

FIG. 4 is a flow chart illustrating a process for routing transactions in accordance with an embodiment of the invention.

FIG. 5 is a flow chart illustrating a process for providing account information in accordance with an embodiment of the invention.

FIG. 6 is a flow chart illustrating a process for authorizing transactions in accordance with an embodiment of the invention.

### DETAILED DESCRIPTION

Turning now to the drawings, systems and methods for transaction routing in accordance with embodiments of the invention are disclosed. Prepaid cards allow consumers to have easy access to funds that have been deposited to their consumer account without the overhead of a traditional financial institution. Funds can be loaded onto (i.e. credited to) consumer accounts associated with the prepaid card (i.e. a prepaid card account) at a variety of participating locations, such as retailers. These funds can be loaded onto a prepaid card (i.e. deposited into the consumer account associated with the prepaid card) through various mechanisms, including direct deposit, check deposit, wire transfers, online deposits, cash deposits, and any other techniques as applicable to the requirements of specific embodiments of the invention. Consumers can then use the prepaid cards in a manner similar to traditional debit and/or credit cards to purchase products using the funds that have been loaded onto the account.

In a variety of embodiments, the Automated Clearing House (ACH) network is utilized to communicate a variety of debits and/or credits to accounts serviced by a financial institution system. ACH is a standardized network for financial transactions widely utilized in the United States. Given a routing number (identifying a financial institution) and an account number (identifying an account), a variety of credit and debit transactions can be performed against the identified account. ACH credit transactions include direct deposit, payroll, vendor payments, and any other deposit to an account as appropriate to the requirements of specific applications of embodiments of the invention. ACH debit transactions include payments to third party accounts, point-of-purchase check conversion, and any other outgoing transfer of funds to a third party. In a number of embodiments, retailers are increasingly utilizing the ACH network for customer payments rather than utilizing credit or debit card networks. However, one of the drawbacks to the ACH network is, given the routing and account data for a particular consumer account, both credit and debit transactions can be executed against that account. That is, the ACH network does not provide a control facility for limiting access to a consumer account on the network. Furthermore, as only the routing and account numbers are needed to access an account, accounts can be susceptible to attack if the routing and account numbers are compromised.

Account servicing systems in accordance with embodiments of the invention provide an abstraction and security service for transactions occurring via an ACH network. Consumer accounts can be provided by an account servicing server system, where the consumer accounts include profile data describing one or more accounts provided by third party financial institution systems. The account servicing server system can provide a specific routing number and ACH account number to a particular consumer account. These consumer account-specific numbers can be provided to third parties wishing to execute credit and/or debit transactions against the consumer account. In this way, the account servicing server system abstracts access to the financial accounts as the ACH routing information for the financial accounts is not disclosed to the third parties. The account servicing server system can then obtain debit and/or credit transactions using the consumer account-specific routing information. A variety of routing rules can then be applied to authenticate that the requested transaction is being provided by an authorized third party, authorized to be performed by the requesting third party, is within the authorized limits for transactions from that party, and/or any other authorization techniques as required by specific applications of embodiments of the invention. The routing rules can also identify specific financial accounts for particular transactions and route the debit and/or credit transactions to one or more of the linked financial accounts. Additionally, a variety of notifications can be provided to a consumer account, such as those displayed on client devices, and contain information related to credit and/or debit transactions targeted toward the consumer account and the actions taken against the financial institution accounts in response to the transactions.

In several embodiments, account servicing server systems allow consumer accounts to identify particular goods that they wish to purchase. In many embodiments, the account servicing server systems facilitate the establishment of savings accounts for each of the identified goods. Routing rules for a particular consumer account can then allocate funds to the savings account. When a consumer account uses the prepaid card to purchase the identified good, the funds to purchase the good(s) can then be taken from the corresponding savings account. In this way, the debit and credit transactions issued using the ACH network can automatically be directed to a savings account for a particular purchase. Account servicing systems can utilize a variety of data such as, but not limited to, demographic information regarding the consumer account, the prepaid card, and/or the identified goods, to provide targeting information to a variety of retailers and/or advertisers. In a variety of embodiments, the targeting information is utilized to target advertising to particular consumer accounts. Additionally, the advertising data can be displayed based on the reload activity associated with the prepaid card. For example, advertising data related to a particular good that is sold at a retailer can be displayed when the consumer account loads funds onto a prepaid card using a terminal at the retailer. By providing a consumer account with an advertisement and/or coupon, account servicing server systems can provide the consumer account with an offer at an opportune time that is particularly useful to the consumer account. Systems and methods for identifying future purchases and targeting advertising data that can be utilized in accordance with embodiments of the invention are described in U.S. patent application Ser. No. 14/587,931, titled “Systems and Methods for Targeting Advertising Based on Future Purchases” and filed Dec. 31, 2014, herein incorporated by reference in its entirety.

Account servicing systems in accordance with a variety of embodiments of the invention include account servicing server systems that can communicate with consumer systems and isolate those communications from payment processor systems and/or financial institution systems. Consumer systems include point of sale systems, client devices, retailer systems, and any other system that can be utilized to obtain and/or display data regarding a consumer account as appropriate to the requirements of specific applications of embodiments of the invention. Account servicing systems can abstract and isolate payment processor systems and/or financial institution systems from the account servicing server system utilizing a banking platform interface. The banking platform interface can allow an account servicing server system to seamlessly communicate with multiple payment processor systems and/or financial institution systems by translating internal command data to payment processor system (and/or financial institution system) command data. The banking platform interface allows for the dynamic routing of communication between consumer systems, account servicing server systems, and payment processor systems and/or financial institution systems. Additionally, the account servicing system can then automatically prepare (and/or translate) data provided as part of the services to command data that is utilized by payment processor systems to execute the requested services. In a variety of embodiments, a payment processor system identifies a consumer account using processor account identifier data. The same consumer account can also be identified by an account servicing server system using account identifier data. Using the banking platform interface, the account servicing server system can dynamically map account identifier data and processor account identifier data in order to identify particular consumer accounts. Systems and methods for providing banking platform interfaces that can be utilized in accordance with embodiments of the invention are described in U.S. patent application Ser. No. 14/718,811, titled “Systems and Methods for Banking Platform Isolation” and filed May 21, 2015, the disclosure of which is herein incorporated by reference in its entirety.

In many embodiments, account servicing systems can detect account activity and target advertising to client devices associated with the active accounts based on location information associated with or implied by the account transactions (e.g. the location of a point of sale), available account balances, and/or available financial accounts. In this way, the account servicing systems allow advertisers to programmatically target advertisements based on the location of a consumer and the funds available to the consumer account. In several embodiments, the account servicing systems directly target advertising to consumer accounts and/or client devices associated with consumer accounts. In a number of embodiments, the account servicing systems provide account identification data identifying consumer accounts and/or client devices associated with consumer accounts as targets to advertising networks that target advertisements to the identified consumer accounts. In accordance with the requirements of specific applications of embodiments of the invention, advertising data includes one or more offers than can be redeemed by a consumer account. Offers can include, but are not limited to, offers that can be redeemed to obtain a discount on particular goods and/or result in a credit to the consumer account's account. In a variety of embodiments, advertising data includes a set of offers, where an offer includes a mapping between a particular product and a discount to be applied to the purchase of that product. That is, advertising data can include a set of mappings between product data describing products and offer data describing offers applicable to the products. Account servicing systems can analyze a consumer account's financial transactions and apply offers to the consumer account's account and/or transactions based on transactions that satisfy the criteria of previously presented (and/or accepted) offers presented to the consumer account. In this way, account servicing systems can facilitate the redemption of offers associated with advertising presented to consumer accounts, thereby encouraging consumer accounts to shop at particular retailers. Systems and methods for targeting advertising that can be utilized in accordance with embodiments of the invention are described in U.S. patent application Ser. No. 14/587,945, titled “Systems and Methods for Targeting Advertising to Prepaid Card Accounts” and filed Dec. 31, 2014, herein incorporated by reference in its entirety.

Occasionally, a debit transaction is received that cannot be fulfilled based on the amount of funds available to the consumer account. In a number of embodiments, account servicing systems can automatically determine fraud in transactions and additionally potentially extend loans to the consumer account. By extending a loan to these consumer accounts, prepaid cards can be utilized to complete these transactions even when insufficient funds are able to be obtained from the funding sources. Any of a variety of loans can be extended in accordance with the requirements of specific applications of the invention including, but not limited to, unsecured loans, secured loans, and installment (e.g. closed-ended) loans. The particular loan product(s) extended to a consumer account can depend on any of a variety of factors such as, but not limited to, the amount of the loan offered, the amount of security associated with the consumer account, the recency of the last loan offered, accepted, and/or paid off by the consumer account, the amount of loans previously offered and/or outstanding, the products being purchased, demographic information describing the consumer account, the balance history of the account, and any other data as appropriate to the requirements of specific applications of embodiments of the invention. In particular, loans can be offered when prepaid cards are utilized to purchase goods at both brick and mortar retail locations and online marketplaces. Systems and methods for determining fraud and/or loan underwriting and for transmitting request data and/or authorization data to payment processor systems that can be utilized in accordance with embodiments of the invention are described in U.S. patent application Ser. No. 14/699,753, titled “Systems and Methods for Loan Underwriting for Prepaid Accounts” and filed Apr. 29, 2015, herein incorporated by reference in its entirety.

It should be noted that, in a variety of embodiments of the invention, a consumer account need not be associated with a prepaid card. That is, a consumer account can provide a routing service for a variety of financial accounts hosted on third party financial institution systems without also providing a prepaid card service. Systems and processes for transaction routing in accordance with embodiments of the invention are described in more detail below.

### Account Servicing Systems

Conducting financial transactions can involve communication between many different parties (e.g., banks, processors, credit issuers, regulators, consumers, etc. . . . ) prior to funds being exchanged between a consumer and a retailer (i.e. between a consumer account and the retailer's account). For example, a consumer account may initiate a purchase at a point-of-sale terminal of a retailer. The retailer system may track certain information for the consumer account, including the items being purchased and the total purchase price and may send this information to a payment processor system. An account servicing server system can utilize a variety of funding sources in order to fulfill the purchase price before and/or after sending the information to the payment processor system. In turn, the payment processor system can communicate with a multitude of financial institution systems in order to process the transaction. Additionally, funds can be deposited into consumer accounts by a variety of parties. In a number of embodiments, a standardized communications network, such as an ACH network, is utilized to communicate these transactions. The transactions can be communicated directly between systems via the standardized communications network or via an intermediary system, such as a payment processor system.

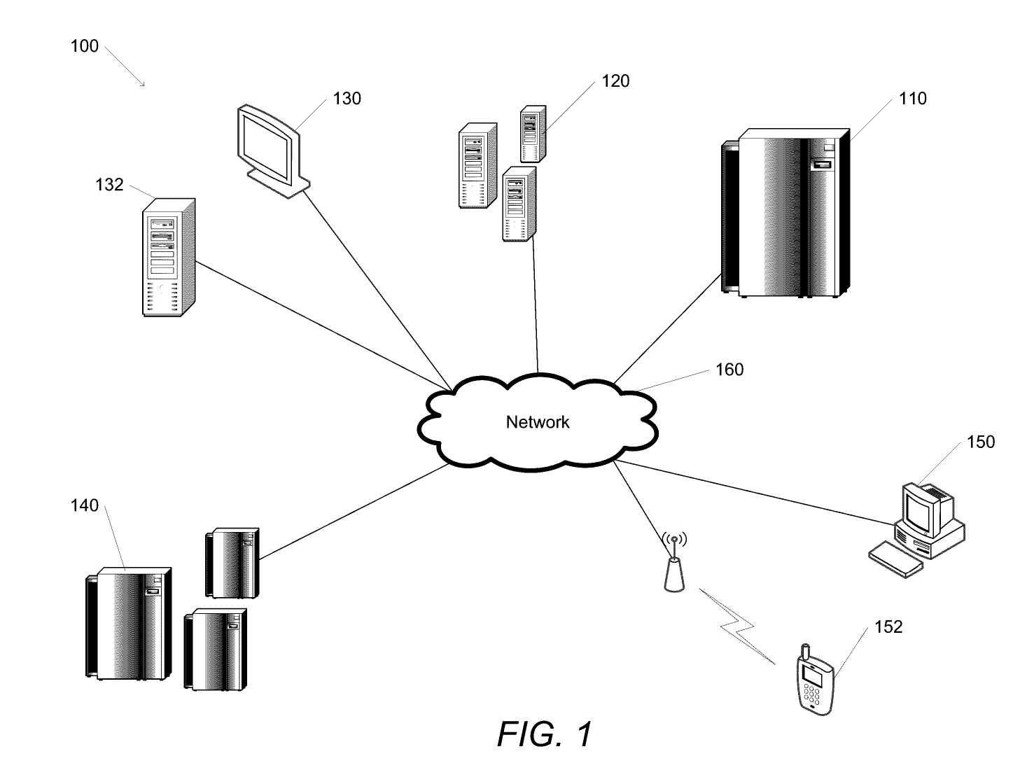

Turning now to FIG. 1, a conceptual illustration of an account servicing system in accordance with an embodiment of the invention is shown. The account servicing system 100 includes account processing server system 110, payment processor systems 120, retailer systems such as point of sale terminals 130 and retailer server system 132, financial institution systems 140, and client devices including, but not limited to, personal computers 150 and mobile devices 152. In many embodiments, the retailer systems 130, financial institution systems 140, and/or account processing server system 110 can host the accounts associated with a variety of financial accounts. It should be noted that any reference to a financial account herein also includes the financial institution system hosting the account associated with the financial account.

These systems communicate through one or more networks 160. Network(s) 160 can include, but are not limited to, the Internet, a local area network, a wide area network, and networks that are shared privately between only a subset of the systems. These private networks can include ACH networks, closed-loop credit networks, and any other network as appropriate to the requirements of specific applications of embodiments of the invention. For example, the payment processor 120 can communicate with the financial institution systems 140, retailer systems, and account servicing server system 110 via the a ACH network such as the FedACH network provided by the Federal Reserve Bank of the United States and/or the Electronic Payments Network provided by the Clearing House Payments Company of Washington, D.C.

Account servicing server system 110 can provide a variety of front-end and back-end services for creating and managing consumer accounts via a number of account servicing processes as appropriate to the requirements of specific applications of embodiments of the invention. Account servicing server system 110 can obtain account data for a prepaid card and/or a variety of financial accounts from a retailer system and/or from a client device. The account servicing server system 110 can assign the consumer account to a payment processor system 120 and/or financial institution system 140. A request that a permanent card (such as a prepaid card or a routing card) can be issued to the account holder associated with the account by the payment processor system 120 and/or financial institution system 140 can also be made. The account servicing server system 110 can also communicate with financial institution systems 140 and/or the payment processor systems 120 to facilitate the execution of transactions between consumer accounts, funding sources, and/or retailer systems. This can include storing a variety of data obtained from the payment processor systems 120, financial institution systems 140, and/or retailer systems and using the stored data to provide account servicing processes. In many embodiments, the account servicing server system 110 includes some or all of the aspects of the payment processor systems 120 and/or the financial institution systems 140. In a number of embodiments, the retailer systems host their own account servicing server system 110.

The account servicing server system 110 can also provide an interface providing account data, user profile data, balance data, transaction data, fee data, and any other data related to the prepaid card and/or the consumer account as appropriate to the requirements of specific applications of embodiments of the invention. In many embodiments, the consumer account is provided funds (cash, check, direct deposit, etc. . . . ) from a point of sale terminal at a retailer along with a prepaid card. The retailer system can then transmit transaction data specifying the amount of funds to be added to the consumer account associated with the prepaid card to an account servicing server system, a payment processor system, and/or a financial institution system as appropriate to the requirements of specific applications of embodiments of the invention. The funds can be loaded to the prepaid card account and/or provided to one or more financial accounts as appropriate to the requirements of specific applications of embodiments of the invention. The loads (i.e. credits) and any debit transactions can include verifying if a particular transaction is allowed for a financial account and/or from a particular source and providing a mapping between the routing/account data for the consumer account and the routing/account data for the appropriate financial account(s). If necessary, the account servicing server system 110 can provide a mapping between account identification data identifying the consumer account and processor account identification data.

When a transaction is executed (and/or requested to be executed), the account servicing server system 110 can obtain request data describing the transaction, including the amount to be debited as a result of the transaction and/or the status (i.e. approved, denied) of the transaction. By way of example, processor request data (i.e. transaction data) can be transmitted by a payment processor system and/or a retailer system. The account servicing server system can determine one or more financial accounts to be utilized to fulfill the transaction. The account servicing server system can then notify the payment processor system that a transaction has been presented and allowed without providing direct access to the financial accounts. In this way, the account servicing server system 110 can facilitate the purchase of products using prepaid cards by utilizing a variety of funding sources. Similarly, the account servicing server system 110 can allow deposits to occur to one or more financial accounts without providing direct access to the financial accounts.

Retailer systems, such as point of sale terminal 130, can be used to purchase prepaid cards, credit funds onto the prepaid cards, as well as process transactions that use a prepaid card associated with a consumer account to make purchases of products and/or services from the retailer. The point of sale terminal 130 can transmit transaction data describing the requested transaction to the retailer server system 132 and/or the processor system 120. In many embodiments, the point of sale terminal 130 communicates directly with the account servicing server system 110. In a variety of embodiments, the retailer server system 132 obtains transaction data from a number of point of sale terminals 130 and transmits the transaction data utilizing techniques similar to those described above. In many embodiments, the account servicing server system 110 stores data obtained from the retailer systems and/or associates the obtained data with particular consumer accounts.

Payment processor systems 120 can process transactions on behalf of financial institution 140, retailer systems, card issuers, and many other types of financial institutions. In many embodiments, prepaid cards serviced by the account servicing server system 110 are associated with a particular payment processor system 120. In a variety of embodiments, the payment processor system 120 issues the prepaid cards for a particular consumer account. Payment processor systems 120 provide a transaction interface that can be utilized to process transaction data. The transaction data can be obtained from any system, including the retailer system. The payment processor system can process data in real-time, on a set schedule, and/or in batch as appropriate to the requirements of specific applications of embodiments of the invention. In a number of embodiments, the payment processor system 120 processes transactions for prepaid cards (or any other account) issued by (or otherwise associated with) the payment processor system 120. In a variety of embodiments, the payment processor system 120 provides a bill payment service between one or more consumer accounts. In a variety of embodiments, transactions can be transmitted processed directly between the account authorization server system 110 and the financial intuition systems 140 and/or the retailer systems without utilizing the payment processor system 120.

Processing transaction data can include determining if a transaction should be authorized. In several embodiments, the transaction data includes transaction amount data describing the requested value of the transaction along with routing and account data identifying a particular consumer account. Authorizing a transaction can include determining if the requesting party is authorized to request the particular transaction from the consumer account. In several embodiments, the balance of the consumer account is based on the funds authorized to be drawn from one or more financial accounts. If a debit transaction is authorized, funds drawn from an account associated with the prepaid card are directed to be transferred to an account associated with the source system identified in the transaction. If a credit transaction is authorized, funds are directed to be deposited into one or more financial accounts. The transfer of funds can include transmitting requests to one or more financial institution systems 140 and/or the account servicing server system 110 in order to execute the requested transaction. In several embodiments, if the transaction is not authorized, additional information can be requested. This additional information can then be utilized to re-process the transaction, potentially resulting in the transaction being authorized. In a variety of embodiments, payment processor systems 120, the account servicing server system 110, retailer systems, and/or financial institution system 140 provide one or more account servicing interfaces to communicate within the account servicing system. The account servicing interface can be utilized by the account servicing server system 110 to obtain and/or transmit data to and from the payment processor system 120, retailer systems, and/or financial institution systems 140. For example, if the payment processor system 120 needs additional information in order to process a transaction, that information can be requested and obtained from the account servicing server system 110 and/or the financial institution system 140. However, it should be noted that any processes that include communication between the payment processor system 120 and other systems within the account servicing system 100 can utilize the account servicing interface as appropriate to the requirements of specific embodiments of the invention.

Financial institution systems 140 service financial accounts for one or more entities. These financial accounts hold funds on behalf of the entities and can accept funds and/or transfer the funds to retailer systems, payment processors, account servicing server systems, or any other system as appropriate to the requirements of specific applications of embodiments of the invention. In a number of embodiments, a routing number is assigned to each financial institution system 140 that uniquely identifies the financial institution systems 140. The routing numbers can be based on a jurisdiction-by-jurisdiction basis (i.e. on a state-by-state or a county-by-county basis) and/or globally identify the financial institution system. In many embodiments, financial institution systems 140 incorporate some or all aspects of the payment processor systems 120. In this way, financial institution systems can issue, service, and/or approve transactions for consumer accounts related to prepaid cards.

Client devices can be used to manage account data associated with consumer accounts, purchase cards, add (e.g. reload) or remove funds from cards, purchase products from a retailer, request and/or accept loans, manage funding sources, view and configure routing rules, and any other transactions or operations as appropriate to the requirements of specific applications of embodiments of the invention. The account servicing server systems 110 can provide account data, balance data, transaction data, routing rule data, financial account data, and/or any other appropriate data to the client devices based on processor request data and/or processor transaction data stored using the account servicing server system 110.

In accordance with embodiments of the invention, a prepaid card need not have the ability to store funds loaded onto the consumer account associated with the prepaid cards. These prepaid cards can be known as routing cards and allow consumer accounts to link a variety of financial account to the routing cards and then utilize the routing cards as a single routing source to securely and dynamically manage credits and debits from the linked financial accounts. Any reference to prepaid cards herein also includes utilizing routing cards to effect similar systems and/or processes.

Although a specific architecture of an account servicing system in accordance with embodiments of the invention are discussed above, a variety of architectures, including client devices not specifically named and account servicing server systems that incorporate aspects of payment processor systems and/or financial institution systems, can be utilized in accordance with embodiments of the invention. Furthermore, it should be noted that any data created and/or transferred within the system can be provided by any system in any manner (i.e. via one or more application programming interfaces (APIs) web services, and/or file-based interfaces not specifically described herein) as appropriate to the requirements of specific applications of embodiments of the invention.

### Account Servicing Server Systems

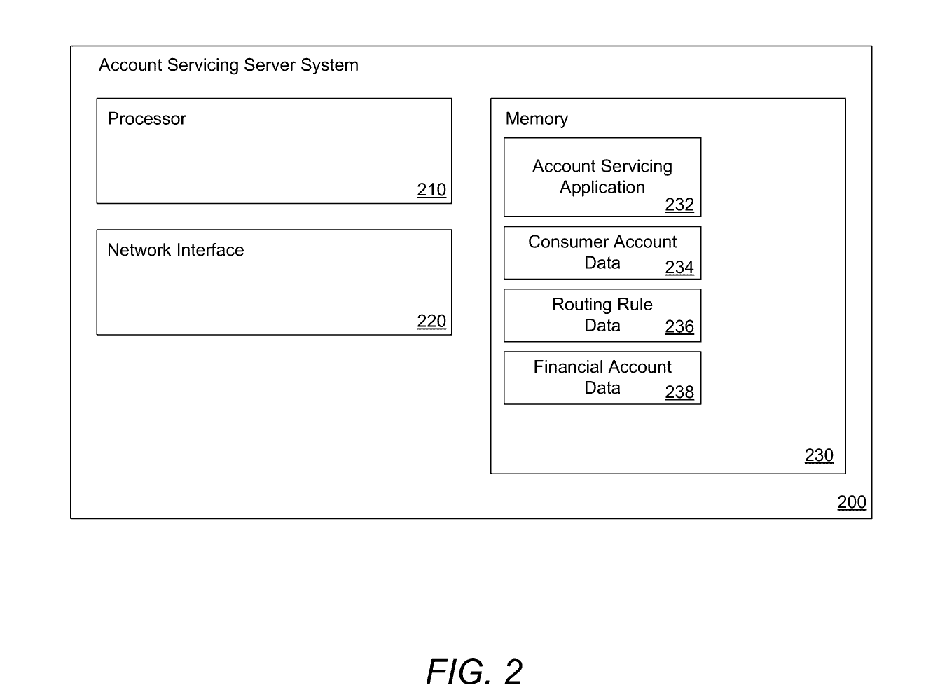

As described above, account servicing server systems can provide a variety of services for consumer accounts associated with prepaid cards. These services can providing a routing and account number to identify a consumer account and maintaining a database of financial accounts and routing rules and dynamically determining which financial account should be utilized to fulfill a particular transaction based on the routing rules. In this way, the services include abstracting and securing access to the financial accounts by providing a controlled interface for all incoming transaction requests. An account servicing server system in accordance with an embodiment of the invention is conceptually illustrated in FIG. 2. The account servicing server system 200 includes a processor 210 in communication with a network interface 220 and a memory 230. The network interface 220 is capable of sending and receiving data over a network connection. In several embodiments, the network connection includes a connection to an ACH network. In a number of embodiments, the network interface 220 is in communication with the memory 230. In several embodiments, memory 230 is any form of storage configured to store a variety of data, including, but not limited to, an account servicing application 232, consumer account data 234, routing rule data 236, and financial account data 238.

The account servicing application directs the processor 210 to perform a variety of account servicing processes. The account servicing processes include processing financial transactions for a consumer account, including processing debits and credits. The account servicing processes can also include managing consumer account data 234 describing the consumer account including, but not limited to, reload activity, balance activity, and location data, consumer account profile data, demographic data, employment information, credit status, income, mailing address, and/or any other consumer account pertinent information. Consumer account data 234 can include data received from a variety of different sources, including client devices, retailer systems, payment processor systems, financial institution systems, and any other of a variety of other sources. Consumer account data 234 can also include metadata describing one or more financial accounts associated with a consumer account. This metadata can include, but is not limited to, routing numbers, account numbers, current balances, available credit, rewards program information, currency information, location data (such as what country the funding source is located in or countries to which the funding source will provide funds), and/or any other pertinent data as appropriate to the requirements of specific applications of embodiments of the invention.

The consumer account data can also be related to routing rule data 236. Routing rule data 236 includes a variety of rules for mapping credit and/or debit requests to a variety of financial accounts. The routing rule data 236 can include metadata describing any aspect of a consumer account, a financial account, source systems, and/or the transaction itself utilized to determine if a particular transaction is capable of being processed, and to what accounts if so.

Financial account data 238 includes a variety of metadata describing financial accounts that are associated with a consumer account. This metadata can include, but is not limited to, the routing number for the financial account, the account number of the financial account, balance data, location data, and any other data as appropriate to the requirements of specific applications of embodiments of the invention. The financial account data 238 can also be associated with (i.e. referenced by) the consumer account data 234.

Although a specific architecture for an account servicing server system in accordance with an embodiment of the invention is conceptually illustrated in FIG. 2, any of a variety of architectures, including those that store data or applications on disk or some other form of storage and are loaded into memory at runtime, can also be utilized. In a variety of embodiments, the memory 230 includes circuitry such as, but not limited to, memory cells constructed using transistors, that are configured to store instructions. Similarly, the processor 210 can include logic gates formed from transistors (or any other device) that are configured to dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices.

A variety of account servicing processes in accordance with embodiments of the invention are discussed further below.

### Creating Accounts

A variety of account servicing processes include creating consumer accounts having an ACH network service identifier. Additionally, existing consumer accounts can be modified to provide an ACH network service identifier. Consumer accounts can be created and/or managed using any of a variety of devices, such as client devices and on-site kiosks. When a request for a new consumer account is received, an (internal) account number for the consumer account can be generated. Additionally, a variety of identifying information, such as a first name, last name, address, employer information, and any other identifying information can be obtained. The identifying information can be utilized to generate profile data associated with the consumer account. Additionally, a routing number and/or a (routing) account number for an ACH network can be generated and associated with the consumer account. It should be noted, however, that the account number provided along with the routing number need not match an internal account number associated with the consumer account. In this way, the security of the consumer account can be improved as no information regarding the consumer account need be provided to third party systems. Additionally, unique account numbers can be generated for each third party system utilizing an ACH network to conduct transactions with the consumer account. This can further secure the consumer account as a breach with a first third party system will not affect the security of the consumer account with a second third party system.

A variety of financial accounts can be associated with a consumer account. In several embodiments, the financial account are identified by providing the routing and account numbers for the financial account. Rules can be defined regarding how credits and/or debits to the consumer account will automatically utilize the linked financial accounts. When a credit and/or debit request is received, the defined rules are processed to execute (or deny) the request. The routing rules can identify to which financial accounts funds should be deposited and/or withdrawn. The routing rules can be global, defined to operate on particular dates, defined to operate on specific requestors, and/or otherwise configured to be processed for particular transactions as appropriate to the requirements of specific embodiments of the invention. The routing rules can include identifying fixed amounts, percentages of the total requested amount, the destination financial accounts, and any other data with respect to the funds and the associated financial accounts as appropriate to the requirements of specific applications of embodiments of the invention.

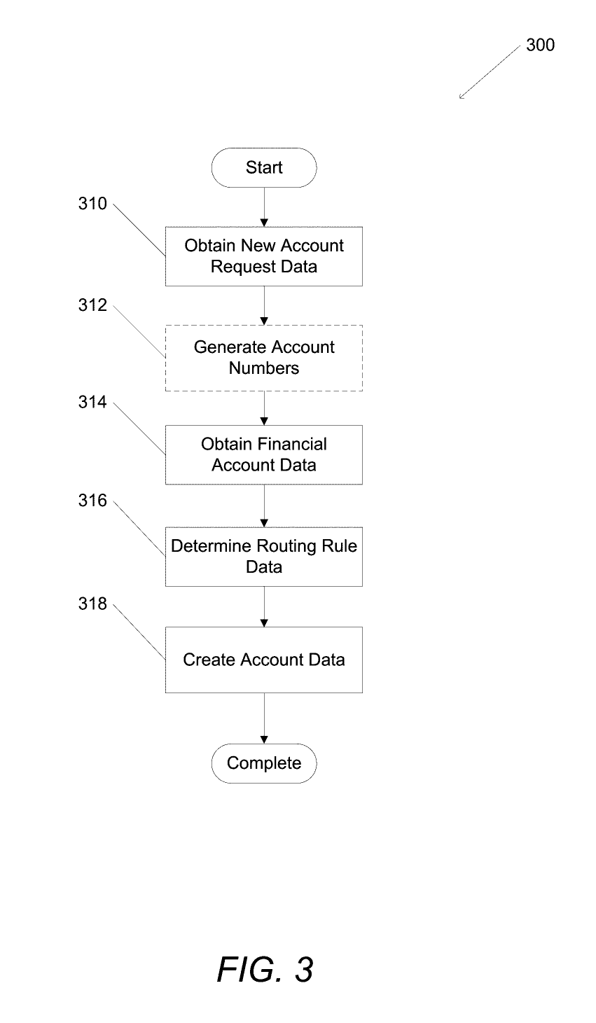

A process for creating accounts in accordance with embodiments of the invention is shown in FIG. 3. The process 300 includes obtaining (310) new account request data and, in several embodiments, generating (312) account numbers. Financial account data is obtained (314), routing data is determined (316), and account data is created (318).

By way of example, a new employee can be hired at a company. A consumer account can be created for the new employee. The employee can then utilize their client device and/or an on-site service (such as HR forms or an on-site kiosk) to provide a variety of identifying information, a password, a PIN, and any other user profile data for the newly created consumer account. The creation of the consumer account includes generating a routing number and an account number for the consumer account. This routing and account number data can be provided to the employer's payroll systems. Come payday, the employee's salary is automatically credited to the consumer account using the ACH network. A prepaid card can also be issued to the employee and associated with the consumer account, providing instant access to the employee's money. Additionally, the employee can also manage the consumer account to include a number of financial accounts and routing rules to automatically save a portion of each deposit. For example, the employee can save a portion of the funds to their consumer account, a second percentage to a third party savings account, and the remaining portion of the funds to pay off the balance of a credit card account associated with the consumer account.

Specific processes for creating accounts in accordance with embodiments of the invention are described above; however, any of a variety of processes, including those that include additional or alternative profile data in the account data and those that include modifying existing account data to include the routing/account data, routing rule data, and associated financial account data, can be utilized as appropriate to the requirements of specific applications in accordance with embodiments of the invention.

### Routing Transactions

When a request for a transaction, such as a credit transaction or a debit transaction, is obtained, a variety of routing rules can be employed to authenticate and/or execute the request. Account servicing processes in accordance with embodiments of the invention include utilizing routing rule data to facilitate the execution of transactions using an ACH network. Obtained transaction data can include a variety of data describing the transaction, including the time the transaction was requested, the system (or party) requesting the transaction, metadata indicating if the transaction is a credit transaction or a debit transaction, the routing and account data for the consumer account to which the transaction is directed, and/or any other data related to the transaction as appropriate to the requirements of specific applications of embodiments of the invention. The transaction data can be authorized utilizing any of a variety of techniques, including those described in more detail below.

Routing rule data can be identified based on the obtained transaction data. The routing rule data can specify a variety of actions to take to execute the requested transaction. The routing rule data can include a variety of metadata describing the actions to take to execute a particular transaction, including identifying a financial account, a mapping between requesting parties and financial accounts, allocations of funds to go to a particular financial account, the times in which the transactions can be executed, and/or any other metadata as appropriate to the requirements of specific applications of embodiments of the invention. The allocation of funds can be a fixed dollar amount and/or a percentage of the requested amount and can be pre-determined and/or determined dynamically (such as based on the total value of the requested transaction) as appropriate to the requirements of specific applications of embodiments of the invention. It should be noted, however, that routing rules can also be directed to the consumer account as appropriate to the requirements of specific applications of embodiments of the invention.

Once particular financial accounts have been identified and, if appropriate, the transaction has been authenticated, transaction request data can be generated for the identified financial account(s). In many embodiments, the routing request data includes a routing number, and account number, metadata identifying if the transaction is a credit transaction and a debit transaction, and value data identifying the value of the transaction. The transaction request data can then be provided to the appropriate financial institution systems associated with the financial accounts in order to process the transaction. In a number of embodiments, the financial institution systems are identified using the routing data. In many embodiments, confirmation data can be obtained from the financial institution systems describing if the requested transaction was successfully executed. In the event that a transaction is not successfully executed, alternative routing rules can be identified to fulfill the requested transactions. In a variety of embodiments, the requested transaction may fail and an appropriate notification can be sent.

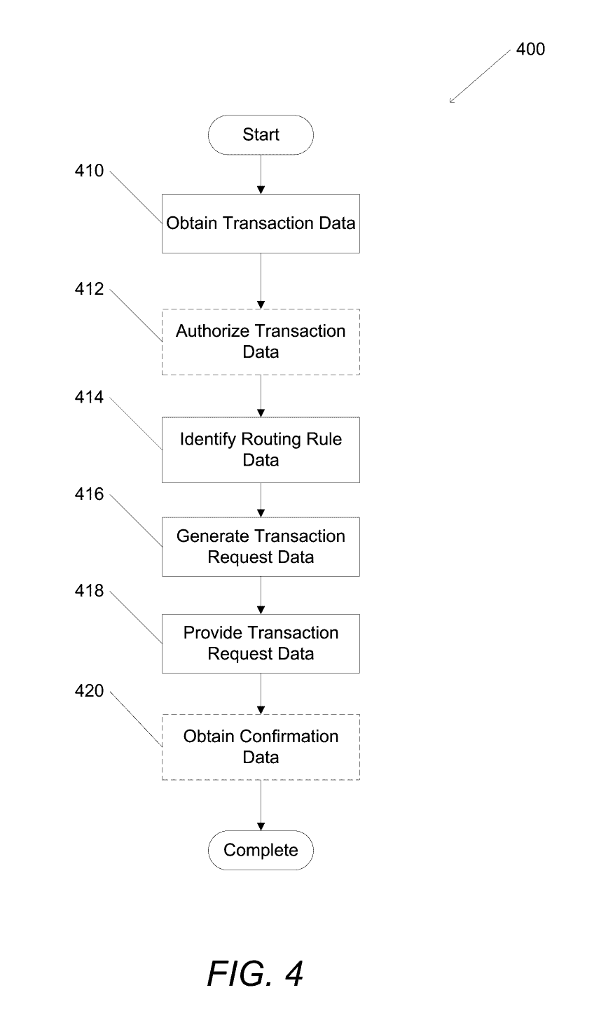

A process for routing transactions in accordance with embodiments of the invention is shown in FIG. 4. The process 400 includes obtaining (410) transaction data and, in several embodiments, authorizing (412) transaction data. Routing rule data can be identified (414), transaction request data can be generated (416) and provided (418), and, in many embodiments, confirmation data can be obtained (420).

Although specific processes for routing transactions in accordance with embodiments of the invention are described above, any of a variety of processes, including those that utilize alternative routing techniques than those described above and those that utilize compound routing rules, can be utilized as appropriate to the requirements of specific applications in accordance with embodiments of the invention.

### Providing Account Information

Once a consumer account is created, the routing and account data for the consumer account can be provided to third party systems so that transactions can be executed using the consumer account. Many transactions can be anticipated and/or requested from trusted sources, such as payroll deposits from payroll provider systems. Account servicing processes in accordance with embodiments of the invention include providing account data to third party systems in order to allow transactions over an ACH network. Data describing a third party can be obtained. The third party data can include the routing and account data for an account associated with the third party, an expected amount of transactions originating from (or destined to) the third party systems, timestamp data describing when the transactions can occur, and any other data identifying the third party and/or the anticipated transactions as appropriate to the requirements of specific applications of embodiments of the invention. In many embodiments, the identified third parties can be authorized. This authorization can involve a variety of checks, such as background checks, investigating public records, utilizing credit inquiries, identifying transaction activity with other consumer accounts associated with the third party systems, and any other checks to identify the third party systems and/or determine potential fraud as appropriate to the requirements of specific applications of embodiments of the invention. Account information, including the routing data and account data, can be provided to the third party. In many embodiments, the routing data and/or account data is generated for the consumer account specifically for the third party system. In a number of embodiments, third party systems can be pre-approved so that transaction requests originating from the third party system are automatically authorized and executed. The pre-approved data can be global to all consumer accounts and/or specified on a per-account basis as appropriate to the requirements of specific applications of embodiments of the invention.

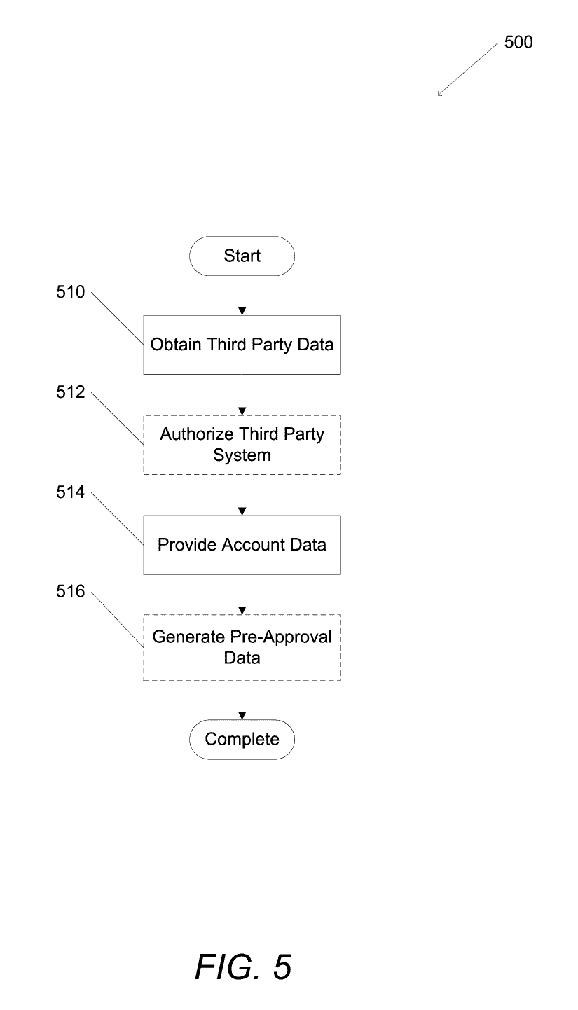

A process for providing account information in accordance with embodiments of the invention is shown in FIG. 5. The process 500 includes obtaining (510) third party data and, in a variety of embodiments, authorizing (512) a third party system. Account data is provided (514) and, in several embodiments, pre-approval data is generated (516).

Although specific processes for providing account information in accordance with embodiments of the invention are described above, any of a variety of processes, including those that authorize third party systems in the absence of a request to accept transactions from the third party system, can be utilized as appropriate to the requirements of specific applications in accordance with embodiments of the invention.

### Authorizing Transactions

One advantage of utilizing a consumer account to facilitate transactions on an ACH network is to provide a facility for authorizing transactions. Once a transaction is authorized, the appropriate routing rules can be processed to execute the transaction. In this way, unnecessary requests can be filtered from the underlying financial accounts, providing a layer of security. A variety of account servicing processes in accordance with embodiments of the invention include authorizing requested transactions. When transaction request data is obtained, the source associated with the request can be identified. The request source can be determined using the transaction request data and/or inferred from the ACH transaction itself. If the requesting source system is authorized, routing rules can be identified and the requested transaction processed utilizing techniques such as those described above.

The requesting source and/or transaction can be authorized based on a variety of criteria and using a variety of techniques. In particular, the requesting source system can be allowed to conduct transactions for a particular consumer account. Particular transaction types, such as credit transactions and debit transactions, can be authorized for specific source systems. For example, an employee may only allow their employer's payroll provider to execute credit transactions on the consumer account. Additionally, sources and/or transactions can be authorized to be executed at particular times. For example, if a consumer has a car payment due on the 15^{th} of each month, the debit transaction from the financial institution servicing the car payment can be authorized to only be executed on the 15^{th} of each month. However, it should be noted that any other authorization criteria, including combinations of criteria, can be utilized as appropriate to the requirements of specific applications of embodiments of the invention.

If the request and/or the requesting source is not authorized, a fraud analysis can be executed. Systems and methods for determining fraud and generating fraud scores that can be utilized in accordance with embodiments of the invention are described in U.S. patent application Ser. No. 14/699,753, incorporated by reference above. Additionally, the transaction can be rejected and/or otherwise not processed. In this way, potentially fraudulent and/or incorrect transactions can be filtered and prevented from reaching the underlying financial accounts. This allows for an additional level of security in addition to the abstraction service provided by not providing the routing and account numbers for the financial accounts.

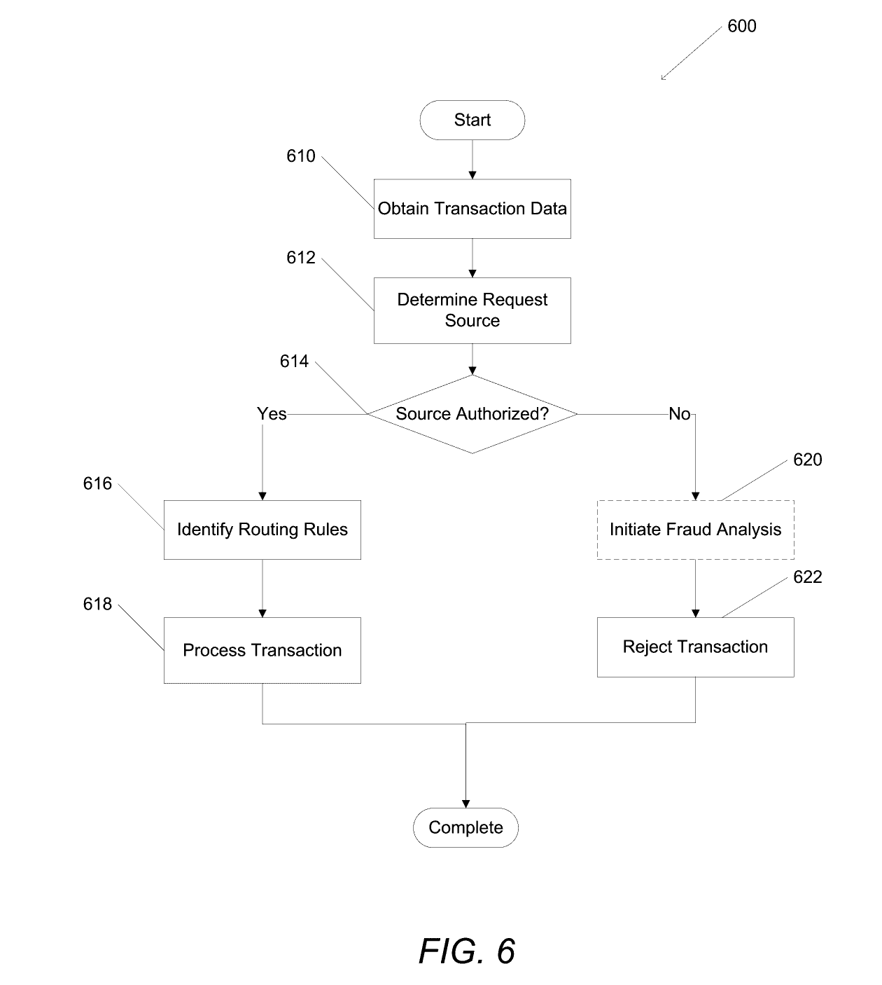

A process for authorizing transactions in accordance with embodiments of the invention is shown in FIG. 6. The process 600 includes obtaining (610) transaction data and determining (612) a request source. If the source is authorized (614), routing rules are identified (616) and the transaction is processed (618). If the source is not authorized (614), a fraud analysis can be initiated (620) and the transaction can be rejected (622).

Specific processes for authorizing transactions in accordance with embodiments of the invention are described above; however, any of a variety of processes, including those employing security techniques other than those described above, can be utilized as appropriate to the requirements of specific applications in accordance with embodiments of the invention.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for routing transactions, comprising:
obtaining transaction data using an account servicing server system, where:
the transaction data comprises metadata identifying a consumer account; and
the account servicing server system comprises a processor and a memory connected to the processor;
identifying routing rule data based on the transaction data using the account servicing server system;
generating transaction request data based on the routing rule data and the transaction data using the account servicing server system, where the transaction request data comprises at least one routing number and one account number identifying a financial account; and
providing the transaction request data to at least one financial institution system using the account servicing server system, where the at least one financial institution system services the identified financial account.

2. The method of claim 1, wherein:
the account servicing server system further comprises a network device connected to the processor and communicating via an Automated Clearing House (ACH) network; and
the transaction data is obtained via the ACH network.

3. The method of claim 1, further comprising obtaining confirmation data using the using the account servicing server system, where the confirmation data is provided by the at least one financial institution system.

4. The method of claim 1, further comprising authenticating the transaction data using the account servicing server system.

5. The method of claim 4, wherein the transaction data is authenticated by:
determining the source system providing the transaction data using the account servicing server system; and
verifying that the source system is authorized to conduct transactions with the consumer account using the account servicing server system.

6. The method of claim 1, wherein:
the transaction data further comprises location data identifying the location that the transaction originated from; and
the routing rule data is identified based on the location data.

7. The method of claim 1, wherein:
the transaction data further comprises metadata identifying the source system providing the transaction data; and
the routing rule data is identified based on the source system.

8. The method of claim 1, wherein:
the transaction data further comprises a timestamp identifying when the transaction was requested; and
the routing rule data is identified based on the timestamp.

9. The method of claim 1, wherein:
the consumer account comprises a routing number and an account number; and
the metadata identifying the consumer account comprises the routing number and the account number.

10. The method of claim 9, wherein:
the transaction data is provided by a source system; and
the routing number and the account number identifying the consumer account are unique to the source system.

11. An account servicing server system, comprising:
a processor; and
a memory connected to the processor and storing an account servicing application;
wherein the account servicing application directs the processor to:
obtain transaction data, where the transaction data comprises metadata identifying a consumer account;
identify routing rule data based on the transaction data;
generate transaction request data based on the routing rule data and the transaction data, where the transaction request data comprises at least one routing number and one account number identifying a financial account; and
provide the transaction request data to at least one financial institution system, where the at least one financial institution system services the identified financial account.

12. The account servicing server system of claim 11, wherein:
the account servicing server system further comprises a network device connected to the processor and communicating via an Automated Clearing House (ACH) network; and
the transaction data is obtained via the ACH network.

13. The account servicing server system of claim 11, wherein the account servicing server application further directs the processor to obtain confirmation data provided by the at least one financial institution system.

14. The account servicing server system of claim 11, wherein the account servicing server application further directs the processor to authenticate the transaction data.

15. The account servicing server system of claim 14, wherein the transaction data is authenticated by:
determining the source system providing the transaction data; and
verifying that the source system is authorized to conduct transactions with the consumer account.

16. The account servicing server system of claim 11, wherein:
the transaction data further comprises location data identifying the location that the transaction originated from; and
the routing rule data is identified based on the location data.

17. The account servicing server system of claim 11, wherein:
the transaction data further comprises metadata identifying the source system providing the transaction data; and
the routing rule data is identified based on the source system.

18. The account servicing server system of claim 11, wherein:
the transaction data further comprises a timestamp identifying when the transaction was requested; and
the routing rule data is identified based on the timestamp.

19. The account servicing server system of claim 11, wherein:
the consumer account comprises a routing number and an account number; and
the metadata identifying the consumer account comprises the routing number and the account number.

20. The account servicing server system of claim 19, wherein:
the transaction data is provided by a source system; and
the routing number and the account number identifying the consumer account are unique to the source system.
